(19) United States
(12) Patent Application Publication
(10) Pub. No.: US 2008/0195724 A1
(43) Pub. Date: Aug. 14, 2008

(54) METHODS FOR INTERACTIVE MULTI-AGENT AUDIO-VISUAL PLATFORMS

(76) Inventor: B. Gopinath, Topanga, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/031,604

(22) Filed: Feb. 14, 2008

Related U.S. Application Data
(60) Provisional application No. 60/889,863, filed on Feb. 14, 2007.

(51) Int. Cl. G06F 15/16; G06F 15/177

(52) U.S. Cl. 709/220; 709/223

(57) ABSTRACT

Multi-agent platforms are able to perform interactive improvisational scripts and/or interactive cooperative behaviors. The platforms can autonomously recognize their situation. Once the platforms discover their situation, they are able to configure themselves accordingly, such as by reacting to motion and proximity. Each of the platforms is embedded with a unique ID.

### CROSS-REFERENCE TO RELATED APPLICATION

This application claims priority of provisional application 60/889,863, filed Feb. 14, 2007.

### BACKGROUND OF THE INVENTION

1. Field of the Invention

The present invention relates to interactive embodied multi-agent platforms (i.e. toys, PDAs, mobile phone, robots, etc.) that are capable of engaging in interactive narratives.

2.

The present invention describes a set of processes that are substantial enhancements to previous inventions in the field of interactive toys. Currently, interactive toys are able to respond to a set of user inputs by using touch sensors, microphones and motion sensors. The responses include sound, motion and light responses. These toys may contain wireless communication capabilities. They also may communicate with a local computer or remote server. The toys may also have some unique identifier such as an RFID tag.

U.S. Pat. No. 7,066,781 describes a children's toy with a wireless tag/transponder. It also describes how an RFID toy might interact with an environment that has been outfitted with RFID readers.

Motion sensing has been used in toys. In general, objects that are capable of autonomously sensing their own motion and orientation and reacting accordingly are called inertial proprioceptive devices. IBM proposed a set of proprioceptive devices such as bats, rackets, pens, and shoes. These devices do not cooperate with other devices. They contend that the advent of small, inexpensive inertial sensors, such as accelerometers and gyros, will enable proprioceptive devices to be realized.

Magic Labs™ sells toy wands that use accelerometers. The user activates a magic spell by moving the wand in a prescribed manner. The spell causes the wand to light up in a particular way.

U.S. Pat. No. 6,626,728 discloses a toy wand that enables a user to activate and control the output of the wand by a sequence of motions. The wand uses a set of embedded accelerometers to detect the motion generated by the user.

Proprioceptive devices are part of a larger technological trend in which computational elements are being embedded into everyday objects such as clothing, appliances, and toys. Xerox PARC has termed this “Ubiquitous Computing”. Research into ubiquitous computing concepts continues in MIT's ongoing Project Oxygen, where they study ways to place computational elements into walls and other common objects such that they become as invisible as the air we breathe.

MIT's Media Lab has proposed many such devices in Things That Think (TTT) Consortium. In particular, Media Lab's Tangible User Interfaces (TUI) seeks to develop ways to interact with a computer using physical objects. The research group, Life Long Kindergarten, has developed intelligent toys using embedded processors. These include an easily programmable processor, called a Cricket, which has been embedded into set of toys like balls and dolls.

U.S. Pat. No. 6,494,762 describes a portable electronic subscription device and service. A portable computer is designed to receive periodic updates from a subscription service. The portable computer stores a log file that contains a record of the portable computer's stimuli. The novel part of this patent is that the content delivered by the subscription service is dependent on the portable computer's log file. The patent suggests that one of the inputs could be an accelerometer; however, the device does not operate with the subscription server in real-time.

L. Bonanni, et al. of MIT's TUI group describe a set of toys called PlayPals in a paper presented at the Conference on Human-Computer Interface. PlayPals are a set of wireless robotic figurines that allow children to communicate playfully between remote locations. They enable coordinated figurine motion and verbal communication. Essentially, they act as advanced robotic walkie-talkies. The present invention is concerned with intelligent networked toys that enable a user to particulate in interactive narratives.

The present invention can be viewed as a novel extension of the interactive storybooks being produced by Leapfrog™. On this platform, a child activates a character's voice or sound by touching the character's “hotspot” on the page with a special wand. In these systems, a single platform contains the computational elements and a set of smart books provides the stories. The child places a book on the platform in order to load a new narrative. A book typically contains multiple pages. The child turns the page and presses “go” in order to load the page. Upon turning the page, a new set of hotspots and corresponding programmed audio responses become active.

This platform is useful because it enables a content provider the ability to capitalize on the company's assets in an interactive format. For example, the platform enables Disney™ to distribute a set of interactive stories based on its popular movies. However, these interactive books fail to provide a complex interactive experience. These systems lack compelling engagement, because interactive books are constrained to two dimensions. The interaction is highly constrained and the child is primarily an observer.

The present invention provides a set of processes that enable a child engage in interactive narratives by using the motion of the platforms. Furthermore, the present invention enables the child to engage in cooperative play with two or more platforms based on motion. It allows children to intelligently access and load new narratives based on proximity of the platforms.

U.S. Pat. No. 7,008,288 presents an intelligent toy with an internet connection capability. The device interacts with other computational elements in its surrounding, which may include internet connected computers, embedded processors, and other intelligent toys. The toy allows complex user behavior by capitalizing on the surrounding internet connected devices. The toy has a unique ID, stored as a user's profile. The surrounding computational elements are able to receive and/or modify the user's profile, thus enabling the user(s) to have context dependent interaction with the toy(s).

However, the '288 patent fails to describe the process of how a toy discovers its situation. Furthermore, it does not describe how the toys receive interactive scripts from a centralized server, nor does it describe how to identify individual parts of the figurine or how sensor data, such as accelerometer data, from these uniquely identified parts can be used.

The present invention is related to recent work on interactive narratives. Currently this field is struggling to answer several questions. Some of these questions include:
1. How to create believable characters in interactive narratives?
2. How to create an interactive story that has both story structure and allows for interesting interaction?
3. How to best allow a user to interact with the story?

Currently, there are several systems that allow a high degree of interaction, but no formal story structure. There are also systems that allow lots of story structure but little interaction. There are relatively few systems that combine both, particularly when you look at physical, multi-agent systems. FIG. 1 illustrates the interaction-story structure trade-off of current interactive narrative products.

Virtual pets (i.e. Tamigachi) and robotic pets (i.e. Sony's Aibo) provide various ways to interact with them but are poor at generating a narrative. In particular, Aibo is able to respond using a behavior-based AI approach that emulates animal behavior, but it does not tell a story. Chatbots (i.e. Alice) enable a person to hold automated chat sessions but the interface is limited.

There have been several attempts to create intelligent interactive narrative systems that use some type of drama manager.

U.S. Pat. No. 6,031,549 by Barbara Hayes-Roth, who works on Stanford's Virtual Theater Projects, describes a system and method for directed improvisation by computer-controlled characters. This patent describes a system of action selection for virtual characters. The system models the mood of the characters in order to help aid action selection. A user is able to input a set of goals and the characters use improvisation to determine the actions that best suits the goals their current mood and specified goals. Specifically, they select which of the subset of feasible actions best fits their mood. A user is able to influence a set of parameters that affect the mood of the characters. The system has been implemented on a computer using computer-generated characters,

The Oz Project at CMU has created a complex drama manager. Their system defines a story as a set of plot points, which are the important moments in a story. The plot points are initially unordered. The Oz project uses a drama manager to select the order of the plot points. Each plot point describes a context for the players to interact. The drama manager monitors the state of the world and waits for the state to get into plot transition configuration. The Oz project is novel because it uses a drama manager that is able to organize the plot points using both the past and the future. At plot transitions, the drama managers uses an evaluation function in order to reason about both the order of the past plot points and possible future plot point ordering, including how the manager may influence the ordering of the future plot points. The drama manager selects a plot point that has the highest probability of generating a good overall plot, as determined by criteria encoded by an artist/programmer. The system has been tested on physical robots.

There exist other frameworks to manage interactive narratives by taking into account some history of the agents. These include CMU's Plot Graphs, Pinhanez's Interval Scripts, and Galyean's Dogmatrix. In these systems, the script is a linear or branching sequence of plot events. The plot events are guarded by monitors that allow the plot to jump to the next plot event only when certain preconditions are satisfied. The systems typically contain some means of providing hints or obstacles in order to direct the user to the next plot event. Between plot events the user is able to engage with the system freely until a plot event criteria is satisfied.

Finally, there has been considerable work on formal automated planning and mix-initiative planning systems to generate novel plots. These systems have been applied to computer games and virtual environments to create interactive narratives in virtual worlds. One group working on these systems is North Carolina State University's Liquid Narrative research group. However, these systems tend to work well only on computer systems where the state of the world can be fully known and controlled; these systems have not been successfully applied to physical multi-agent systems.

### SUMMARY OF THE INVENTION

The subject invention relates to multi-agent platforms that are able to perform interactive improvisational scripts and/or interactive cooperative behaviors. The platforms can autonomously recognize their situation. Once the platforms discover their situation, they are able to configure themselves accordingly, such as by reacting to motion and proximity. Each of the platforms is embedded with a unique ID.

In certain embodiments, a user is able to participate in an improvisational script or set of cooperative behaviors by physically interacting with the platforms. The platform may be configured with a variety of sensors including a set of uniquely identified accelerometers. The platform uses the outputs of its accelerometers to modify its behavior or internal state or the behavior and internal state of other co-located platforms.

One of the benefits of the subject invention is that the content of the interactive scripts or behaviors can be authored and managed to support brand management. For example, a company may have a set of characters that behave in a particular way. In order to manage the characters' brand, they often wish to have full control how these characters are portrayed. This is easy if the characters' actions are fully scripted as in movies or cartoons; however, it becomes difficult when the characters are interactive. The subject invention enables complex interaction with a set of embodied characters while enabling the company to manage the branding of these characters.

### BRIEF DESCRIPTION OF THE DRAWINGS

FIG. 1 diagrammatically illustrates the interaction-story structure trade-off of prior art interactive narrative products.

FIGS. 2A and 2B illustrate a proximity discovery and configuration process.

FIG. 3 illustrates a process of downloading an interactive script or behavior from a remote server based on a platform's situation.

FIG. 4 illustrates a process of creating an accelerometer network among multi-agent interactive platforms.

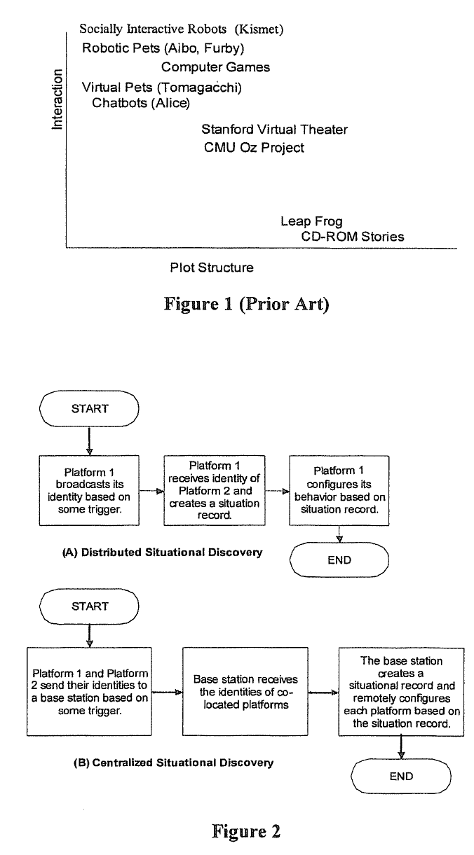

### DETAILED DESCRIPTION OF THE INVENTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods and devices are omitted so as to not obscure the description of the present invention with unnecessary detail.

### Overview

The present invention relates to an interactive audio-visual platform that is able to coordinate with other audio-visual platforms in order to perform non-deterministic interactive scripts and interactive cooperative behaviors.

In certain embodiments, the invention provides a process wherein a user provides inputs to the platform by moving the platform or a part of the platform, and the platform senses this motion by using an embedded accelerometer. The moved platform or other co-located platform responds to the sensor output by modifying its immediate behavior or internal state. The audio-visual platform may be modeled after a real-life or copyrighted character whose actions and responses are consistent with the character, thereby maintaining the integrity of the character's reputation and/or brand.

In certain embodiments, the invention provides a process of using unique IDs embedded in an audio-visual platform in order to allow the platform to determine the situation, including the proximity of other platforms. The platforms then configure their behaviors and the overall interactive script based on their perceived situation.

### Proximity Discovery and Configuration Process

One aspect of the invention relates to uniquely tagged audio-visual platforms. In particular, the invention includes a process of being able to create context aware platforms in order to support interactive scripts. The platforms understand their proximity to other platforms, called a situation, by sending and receiving unique IDs among one another. They configure their behaviors or roles in an interactive script based on their situation.

Previous methods do not provide a process to dynamically configure agents based on their proximity. The process of the subject invention allows platforms to be dynamically configured. This allows a user to interact with the platforms in a natural way. Furthermore, using a unique ID allows other devices are able to identify not only the type of platform, but distinguish one particular platform from all of the other similar platforms.

FIGS. 2A and 2B illustrate two ways to perform a process referred to as Proximity Discovery and Configuration in which: (1) a unique ID is embedded into a platform; (2) the platform broadcasts its ID based on some trigger; (3) the platform receives IDs of other platforms in its vicinity and creates a situation record; and (4) the platform configures its behavior or state based on the situation record. The method illustrated in FIG. 2A is distributed, whereas the method illustrated in FIG. 2B is centralized.

The process of proximity detection and configuration may use the signal strength of a Radio Frequency (RF) communication device in order to determine the approximate distance and location of a different platform or platform(s). The process may then determine the relative location of all platforms using the above technique and configures the platforms accordingly. The process may use two or more RF communication devices with different communication ranges in order to determine their relative distances and configure the platforms accordingly.

### Situational Downloading

Previous methods related to interactive toys do not allow a platform to download an interactive script or behaviors from a remote server based on its situation. The subject invention allows new and relevant content to be downloaded to the platform. The platform may load new behaviors from the server or simple activate a known set of behaviors previously stored. This adds to the enjoyment of the platform.

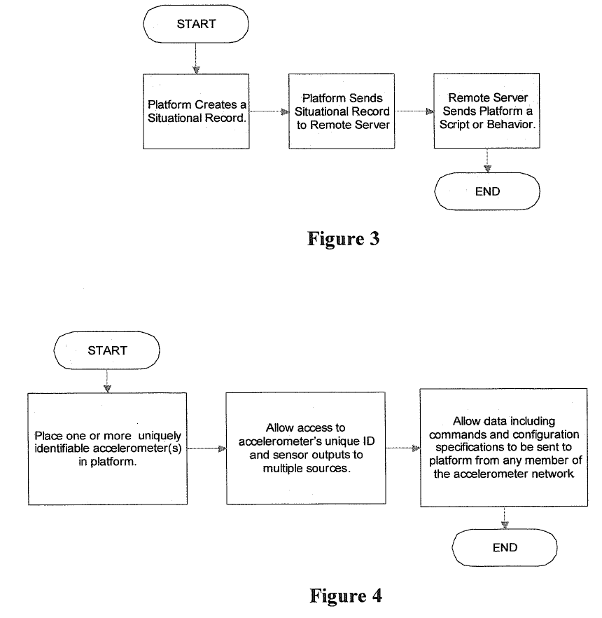

FIG. 3 illustrates a process of downloading an interactive script or behavior from a remote server based on a platform's situation in which: (1) a platform forms a situational record as previously described; and (2) the platform connects to a remote server and downloads a new script or behavior based on the situational record.

### Accelerometer Network

Another aspect of the present invention relates to using accelerometers in multi-agent interactive platforms; specifically, embedding uniquely identified accelerometers (UIA) into the platform. Processes using these UIA relate to coordinating behaviors and data between platforms and coordinating the platform with a remote accelerometer server.

In the prior art, accelerometers have been used to provide inputs to interactive toys and audio-visual platforms; however, there was no way to uniquely identify the accelerometers or their associated data by other platforms or computational devices. The process of the present invention allows motion of individual parts of the platform to be detected.

FIG. 4 illustrates a process related to interactive audio-visual platforms in which: (1) the platforms are embedded with one or more uniquely identifiable accelerometer(s); and (2) the platforms are placed in an accelerometer network.

### Accelerometer Triggered Platform Events

The present invention encompasses a process in which embedded accelerometers trigger events and behaviors, including actions/behaviors of other co-located platforms or actions of a remotely connected server.

Previous methods allow a toy to respond to its own motion, whereas the subject invention allows one or more platforms to coordinate their behavior based on the motions of multiple platforms. This allows for complex interaction between the platforms. Specifically, when engaging in a multi-agent interactive script, the motion caused by the user in one platform can cause a reaction in a second platform. Thus, the present invention encompasses a process in which: (1) a first platform is moved and the one or more uniquely identified accelerometers detect said motion; (2) this information is sent to a second platform; and (3) the second platform modifies its behavior or state based on accelerometer data received from the first platform.

The process may include some means to respond to specific sequences of motions by one or more platforms. This may include a pattern matching or a filtering process or mode estimation techniques. A specific sequence of motions may cause a certain behavior/action or state change in one or more platforms. The motion of one platform may be explicitly interpreted as a yes/no response by one or more platforms.

### Accelerometer Triggered Server Events

The present invention further encompasses a process in which: (1) a platform is moved and the uniquely identified accelerometers detect the motion; and (2) this data is sent to a remote server and the server responds by sending data to the platform based on accelerometer data.

The server might be triggered based on a specific action the user makes with the platform. This enables a system where downloads are based on the user's specific interaction. It also allows time sensitive downloads to be delivered to the platform with the knowledge the platform is currently be moved.

### Brand Management (Evaluation Function/Brand Rules)

This section discusses ways of providing action selection based on a set of brand constraints. Previous system used evaluation function to guide actions; however, the subject invention explicitly incorporates accelerometer data, proximity data, and brand management.

The present invention encompasses a process of platform action selection in which: (1) the platform is configured with an evaluation function that encodes ranking rules for behaviors for one or more platforms based on proximity and accelerometer data (the state of the system may include one to some or all of the past accelerometer data or proximity data): and (2) the evaluation function then outputs a set of preferred behaviors or actions. This process may be performed in either a centralized or a distributed fashion in which one or more platforms contribute to the evaluation function.

The rules may be based on branding rules established by a company, such as for a copyrighted character. The rules may be dynamic (i.e., they may be affected by past actions including proximity and accelerometer data).

### Teaching Behaviors

This section introduces a method that allows a user to teach the platform behaviors. Teaching the agents allows the user to create new and exciting interactions. Constraining the types of things an agent learns preserves the agent's character. This is particularly important when the character's brand needs to be carefully managed.

The present invention encompasses a process in which: (1) the platform detects an unknown situation; (2) the platform provides a means to input a new behavior; and (3) the platform uses the inputted behavior next time it encounters the same detected situation.

The situation may be some combination of proximity, accelerometer data, or other sensor data. The process may include a means to encode branding rules such that it limits the behavior able to be taught to the platform.

### Implementation

One purpose of the present invention is to provide brands with compelling interactive audio-visual platforms (i.e. dolls, toys or mobile phones) based on their assets. For example, Disney™ may use the interactive platform to create a set of interactive dolls based on the characters in the movie Aladdin™.

The present invention may be implemented using a variety of platforms. The platform may be an interactive doll or a portable computing device such as a cell phone or PDA. In the case of the portable computing device, a character could be presented as an animation displayed on the screen of the device.

One of the important aspects of the present invention is a process that allows platforms to coordinate within the context of an interactive narrative based on one another's motion. Motion sensing may be used in many ways. Consider a scenario where the characters are participating in a sing-along. Motion may be used to cause one or more characters to speak or produce a sound effect. Motion could also be used to modulate a song.

The system may explicitly ask how to move forward with the story and then wait for motion response from a user. In this regard, it is a type of “choose your own adventure” using a physical motion interface. For example, if a first character asks the question, “Who wants to play with me?”, the system waits for a response. Then the user moves a second character. This motion is detected by the accelerometers and the data is sent to the first character. The first character then assigns the second character as his friend. A behavior evaluation function may be modified to allow only “nice” responses between the characters.

Consider another scenario in which one platform/character is tossed into the air. The present invention allows one or more other characters to say, “Look Out!” in response to this action.

Many possible inertial sensors may be used in order to detect the motion of the platforms. For example, there are low-cost MEMS accelerometers and low-cost optical accelerometers. Furthermore, one may use small low-cost MEMS gyros in order to sense angular rates.

The subject invention provides a system where the platforms are able to respond in several ways. The responses may include but are not limited to Situational Reactions, Narrative Actions, or Plot Transitions.

Situational Reactions are behaviors that provide immediate and character appropriate reactions. They allow the characters to respond to inputs in some character specific way. However, the reaction is not part of some plot development. For example, one character might say “Ouch”, when it is dropped on the floor.

Narrative Actions are actions that are used to push a narrative forward. The action may provide hints or obstacles to direct the user into a particular configuration or cause a character to describe some part of the current story.

Plot Transitions are internal state changes that modify how the characters react to one another.

One aspect of the present invention is to provide interactive multi-agent toys with Situational Awareness. For example, a character may react when it detects that another character is missing. Consider an improvisational script for the Mad Hatters Tea Party. When a user places Alice™ and the Mad Hatter™ together around the table, they determine that they are participating in a tea party. However, upon determining that the teacup is missing, a possible reaction based on situational awareness would cause Alice to say, “Where is the teacup?”

Situational awareness may be increased by installing a multitude of sensors on the platforms. For example, each platform may contain an infrared (IR) transceiver with a narrow field of view in order to transmit and receive data between platforms. The general orientation of the platforms (i.e. is one platform facing another) may be determined by detecting which platforms are able to communicate with one another. A script rule may specify that characters only talk to one another when they are facing each other.

The relative position of the platforms may be determined by using the RF signal strength between the platforms. Specifically, platforms that maintain high signal strength will tend to be physically closer than platforms that have low signal strength. This information may be used to control which characters directly interact.

Using two or more RF communication devices with different ranges would allow objects to understand their proximity to one another. For example, using both Bluetooth class 3, with a range of three feet, and class 2, with a range of thirty feet, on a single device would enable a platform to categorize other objects into two classes: nearby objects and more distant objects.

It will be recognized that the above-described invention may be embodied in other specific forms without departing from the spirit or essential characteristics of the disclosure. Thus, it is understood that the invention is not to be limited by the foregoing illustrative details, but rather is to be defined by the appended claims.

What is claimed is:

1. A method for controlling an operational parameter of an audio-visual platform comprising:
embedding a unique identification code in a first platform;
the first platform broadcasting its identification code in response to a stimulus;
the first platform receiving an identification code broadcast by at least one other platform;
the first platform creating a situation record based on the received identification code;
the first platform configuring an operational parameter based on the situation record.

2. The method of claim 1 wherein the operational parameter comprises one of a behavior and an operational state.

3. The method of claim 1 further comprising the first platform measuring a signal strength of the received identification code and determining an approximate distance to the other platform.

4. The method of claim 3 wherein the first platform creates the situation record based on the received identification code and the approximate distance to the other platform.

5. The method of claim 1 further comprising the first platform downloading the operational parameter from a remote server.

6. The method of claim 5 wherein the operational parameter comprises one of a behavior and a script.

7. A method for controlling operational parameters of audio-visual platforms comprising:
embedding respective unique identification codes in first and second platforms;
the first and second platforms broadcasting their identification codes in response to a stimulus;
a base station receiving the identification codes;
the base station creating a situation record based on the received identification codes;
the base station remotely configuring an operational parameter of at least one of the first and second platforms based on the situation record.

8. The method of claim 7 wherein the operational parameter comprises one of a behavior and an operational state.

9. The method of claim 7 further comprising the base station measuring a signal strength of each of the received identification codes and determining respective approximate distances to the first and second platforms.

10. The method of claim 9 wherein the base station creates the situation record based on the received identification codes and the approximate distance to at least one of the first and second platforms.

11. A method for controlling an operational parameter of an audio-visual platform comprising:
providing a first platform having an accelerometer;
moving the first platform;
detecting motion of the first platform with the accelerometer;
the first platform sending accelerometer data to a second platform;
the second platform configuring an operational parameter based on the accelerometer data.

12. The method of claim 11 wherein the operational parameter comprises one of a behavior and an operational state.
